(19) United States
(12) Patent Application Publication
(10) Pub. No.: US 2012/0066715 A1
(43) Pub. Date: Mar. 15, 2012

(54) Remote Control of Television Displays

(76) Inventors: Shashi K. Jain, Hillsboro, OR (US); Prashant Gandhi, Gilroy, CA (US); James P. Melican, Hillsboro, OR (US); Rita H. Wouhaybi, Portland, OR (US); Mark D. Yarvis, Portland, OR (US); Gunner Danneels, Beaverton, OR (US)

(21) Appl. No.: 12/974,020

(22) Filed: Dec. 21, 2010

Related U.S. Application Data
(60) Provisional application No. 61/381,791, filed on Sep. 10, 2010.

(51) Int. Cl. H04N 5/445; H04N 5/66; H04N 7/173; G06F 15/16

(52) U.S. Cl. 725/38; 709/217; 348/739; 725/118; 348/E05.133

(57) ABSTRACT

Video sources may be located on the Internet and particular videos at those sources may be selected for subsequent replay by using graphical controls provided, for example, in connection with a browser. These controls may permit the use of select, particular video segments for subsequent replay by adding them to a playlist. Then when the user has assembled the playlist in the order desired, the play of the playlist can be selected. The playlist video may then be displayed for the user on a remote display, such as a high definition television display. At the same time, the user's computer screen may display a control view which allows the user to view and add annotations and to control the play of a video on the high definition television screen.

### CROSS-REFERENCE TO RELATED APPLICATION

This application is a non-provisional application claiming priority from provisional application Ser. No. 61/381,791, filed Sep. 10, 2010, incorporated herein by reference.

### BACKGROUND

This relates generally to television displays and, particularly, to enabling television displays to be remotely controlled.

Television displays are becoming increasingly popular for the display of web based content. Thus, television displays, including high definition television displays, may be used to display information that is accessed by the user from the Internet, generally through the user's personal computer. This personal computer can control the experience that the user has with the video on the television, including additional information that enhances the video content.

In many cases, the personal computer is not directly connected by wires to the television display, but, instead, a wireless connection is provided, such as Intel's Wireless Display (WiDi) wireless connection. In this way, the user can send video obtained from the Internet to be displayed on a television screen.

### BRIEF DESCRIPTION OF THE DRAWINGS

FIG. 1 is an architectural depiction of one embodiment of the present invention;

FIG. 2 is a front elevational view of a computer display according to one embodiment;

FIG. 3 is a depiction of a personal computer display in accordance with one embodiment of the present invention;

FIG. 4 is a flow chart for one embodiment of the present invention;

FIG. 5 is a flow chart for one embodiment of the present invention;

FIG. 6 is a flow chart for another embodiment of the present invention;

FIG. 7 is a flow chart for still another embodiment of the present invention;

FIG. 8 is a depiction of a client server system in accordance with one embodiment of the present invention;

FIG. 9 is a flow chart for yet another embodiment of the present invention; and

FIG. 10 is a flow chart for an audio manager in accordance with one embodiment of the present invention.

### DETAILED DESCRIPTION

In accordance with some embodiments, content obtained from the Internet, such as video content, from sites such as YouTube, may be first rendered on the user's personal computer (PC) and then displayed on a television display remote from the host computer used to download the information. For example, the information may be sent from the personal computer wirelessly to an adapter for display on a television. The controls for television display may be displayed at a location different from the television, namely, on the host computer display. The host computer can be used for other functions by simply displaying the television controls in a window of reduced size on the host computer display. This leaves the rest of the host computer display screen for running other functions.

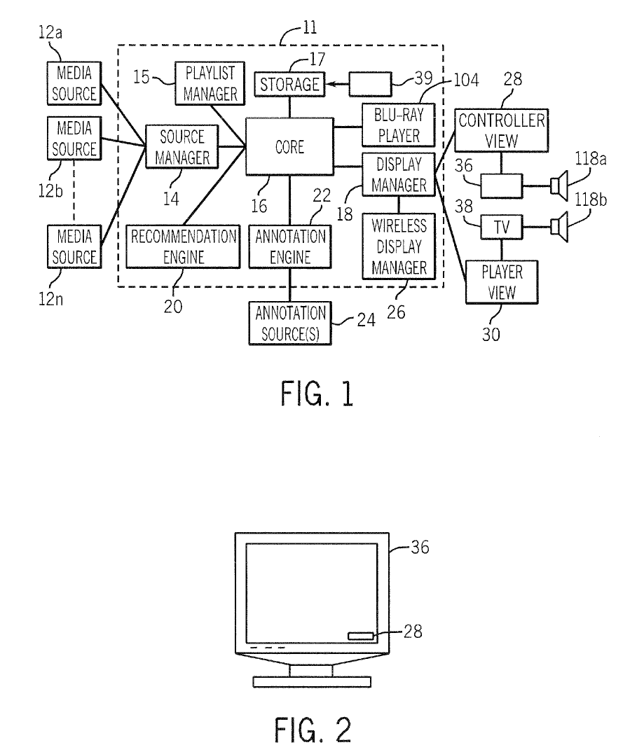

Referring to FIG. 1, a remote video display system may include media sources 12a, 12b, and 12n. These media sources may be any kind of computer application, video information or audio information which may be streamed from the Internet, available on a local area network, or stored on a device in the local system. Thus, the information may be obtained by a source manager 14, coupled to a video manager core 16. The source manager 14 extracts and abstracts media from different sources. In one embodiment, the source manager may add distinct wrappers for media from different sources like YouTube, Viddler or Hulu. In another embodiment the source manager may add distinct wrappers for host-based media players or productivity applications.

The video manager core 16 may be part of the user's host computer 11. The host computer 11 may, for example, be a cell phone, a laptop computer, a desk top computer, a mobile Internet device (MID), a netbook, storage server, or a tablet, to mention a few examples. The video manager core coordinates all of the other components and includes things like settings and preferences. It also is responsible for rendering the various media items into a presentation to be displayed on the remote display. For example, it may support picture in picture where two different media sources are composited before being sent for display.

The host computer 11 may include a display manager 18 that controls the dedicated displays connected to the host computer 11 and remote display on a television. Thus, the display manager 18 may be coupled to a wireless video manager 26, which controls remote displays on a television screen. The wireless display manager may be Intel's WiDi technology platform. The display manager 18 may also discover and configure the various available displays. It may also determine which displays are most appropriate for the available media. It may, for example, determine how close a display is to the host computer 11, for example, using wireless proximity sensing. As another example, the display manager 18 may determine which television was used last or most often with the display manager and default the remote display to that television. In other situations, the host display manager 18 may make its decisions based on privacy settings assuring that sensitive videos, as defined by the user, will not display on public screens.

The playlist manager 15 controls the order in which media can be played. The user can queue various media files and/or streams in the playlist. The playlist manager maintains the state of the playlist between restarts so the user can resume a playlist from the point it was stopped.

The recommendation engine 20 provides recommendations to the user for watching media relevant to what has been watched in the past in some embodiments.

The controller view 28, shown in FIG. 2, is a control graphical user interface on the host computer display 36, displayed in reduced size, such as via an overlay on the user's personal computer monitor display. The player view 30 is the actual view of the video which may be presented, for example, on the television screen 38, coupled either wirelessly or by a wired connection.

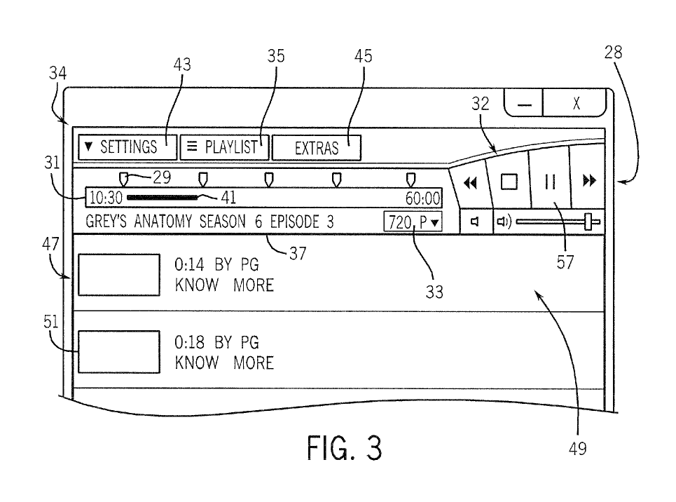

Thus, referring to FIG. 3, the reduced size controller view display on the user's host computer may include controls 32 to control the playback of video information. It may also include additional controls 34 to adjust settings, to play video selected on a playlist of video to be played, to look at the history of video to be displayed, and to control the size of the display 38 (FIG. 1). Also, a graphical user interface button 33 may be used to select display type (interlaced or progressive) and resolution (e.g. 720 P).

The annotation engine 22 (FIG. 1) gathers contextual annotations to display along with the media, which is currently playing. In some embodiments, contextual annotations and tags may be overlaid on the actual media being played. In other embodiments, these contextual annotations could be displayed with the controller view 28. Such tags may include product placement tags, extra information about places, things, and people that are displayed in the media, comments for the user's social network, and the like. These annotations can be supplied by the actual content publisher, by third party providers and as an add-in service, to mention a few examples.

In order to implement the annotation engine 22 functions, the controller view 28, shown in FIG. 3, may be used. Particularly, the controller view may include a time line display user interface 31 that shows the amount of time that has elapsed in the available video currently being displayed. Thus, in the depicted example, the time line shows the current time (10:30), the total time for the presentation (sixty minutes), and may include a bar 41 that indicates how much of the video has already been displayed. Along the top edge of the time line user interface 31 may be markers 29 that indicate the availability of an annotation, associated with the video displayed at a particular time, indicated by the position of a marker 29, along the time line user interface 31. In addition, in the course of the display on the television display 38, a small marker (not shown) may appear on the television display. This reminds the viewer that an annotation is available. Moreover, on the computer display 36, in association with the time line 31, the same marker icon 29 may be used. The user can select the appropriate marker icon 29 on the controller view 28 to cause the display of the annotation, not on the television display 38, but, rather, on the computer display 36.

Thus, in some embodiments, two displays may operate at the same time. For example, in some embodiments, the computer display may provide a private display for one user or for fewer users than the television display 38.

These annotations may be displayed on the host computer display as little markers 29 on a controller time line 31. When playback reaches a marker, the appropriate action is triggered and a display manager 18 can display a small visual queue to the user on the television display indicating the contextual information is available. The user can also expand the controller view on the host computer display to show more information about the annotation. This allows the user to view annotations without disrupting the overall media experience.

In some embodiments, the annotations can be color coded, depending on the source and/or type of the annotations. For example, friends' comments may be red, advertisements are blue and video annotations are green, while the rest are yellow. Thus, the annotation engine 22 controls when annotations stored in the annotation source 24 are provided on top of existing video playback. The annotation source 24 may also be internal to the computer 11.

The controller view 28 may also include a graphical user interface button 43 for settings. This allows the user to input various user preferences for disambiguating audio and video, including the various inputs described hereinafter. Similarly, a graphical user interface button 45 for extras may be provided which may provide an indication of what are the available annotations.

When the user selects the playlist button 35, in one embodiment, a dropdown menu 47 is generated which includes a plurality of entries 49 for each of the available videos in a sequence from top to bottom that the videos would otherwise be played in. Each entry 49 may include a thumbnail depiction 51 from the video and a textual description extracted from the video metadata. The sequence defined in the playlist may be changed by the user. For example, in one embodiment, each of the entries 49 may be dragged and dropped to reorder the sequence of video play.

The wireless display manager 26 may be a mechanism for interfacing with a wireless display, such as through Intel's WiDi technology, to initiate and set up a connection with a High Definition television.

In some embodiments, the selection of video for display on the host computer 11 display 36 or on the television screen 38 may be made using the user's browser. For example, in one embodiment, a plug-in may provide a graphical user interface button so that, when the user is looking at information on the Internet that the user wishes to view, the user can select (e.g. by a mouse click) this button (in the form of a graphical user interface) to cause the information to be added to a playlist. Then another graphical user interface button 35, on the controller view 28 of FIG. 3, can be selected when the playlist has been defined and the user wants to play the video. When the user selects “play,” the user selected video is displayed on the television screen 38, as opposed to the personal computer screen 36. As a result, the video is shown on the television screen, as opposed to the personal computer display. However, the controls for controlling the display are available on the user's personal computer monitor display. As a result, the controls are provided on one screen and, remotely, the video is displayed on the television screen.

To accomplish these capabilities several steps may be automated so that content may be sent from a video application, browser, or web page to a television, such as a high definition television. This may be done by checking for an available wireless display adapter or wired adapter such as High Definition Multimedia Interface (HDMI) or DisplayPort having been plugged in. The application is opened, scanned, and connected to the nearest adapter. The nearest wireless adapter can be located using any available wireless device discovery technology. The screen mode may be then set to “extend” to another display (i.e. a television 38) and the television 38 may be automatically set to the appropriate high definition setting. The player view 30 on the television may be set to full screen display and the controller view 28 on the host computer may be set up as a reduced display. Then media viewing may be separated from media control.

In some embodiments of the present invention, sequence may be implemented in software, hardware, firmware, network resource, or a combination of these. In software implemented embodiments, a sequence may be implemented via instructions stored on a non-transitory computer readable medium, such as a semiconductor, optical, or magnetic memory. The instructions may be executed by an appropriate processor. In some embodiments, the instructions may be stored in a memory separate from the processor and in other cases one integrated circuit may do both storage and execution of instructions. For example, the video manager core 16 may include a storage 17 that stores instructions 39.

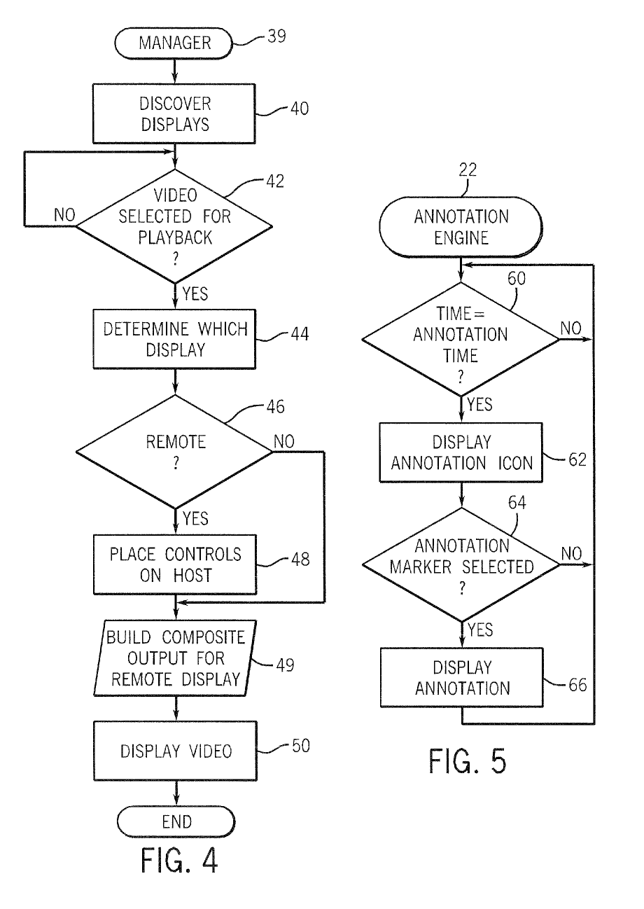

Thus, a sequence 39 implemented by the video manager 16 begins by discovering the displays that are available, as indicated in block 40 of FIG. 4. In the case of wireless displays, a wireless discovery procedure may be implemented to identify all available displays or the closest proximate wireless displays (using a typical conventional wireless discovery protocol). In addition, any wired television displays may be identified, for example, because they use HDMI ports. Then a check at diamond 42 determines whether video has been received or selected for a playlist.

The user may be browsing the Internet and the user's browser may provide a button to select video, located on the Internet, to add to a list for subsequent playback. Local video can be handled in the same way. That list of video to be played back subsequently is called a playlist herein. Thus, the user can add any video found on the Internet to the user's playlist. Of course, in some embodiments, the user can precipitate a playlist display and can reorder and edit the playlist.

Then when the user is ready to play back the video, the user can simply operate a playlist button 35 of FIG. 3 in the form of a graphical user interface. Thus, the user selects the play/pause button 57, causing the entire playlist to be played, one video after the other, in the order desired by the user, as indicated in diamond 42. When the user selects play through the controller view 28 at diamond 42, the television screen may be selected for the playback (block 44) and this information is automatically displayed in the appropriate size on the television, as indicated in block 46. At the same time, a controller view 28 graphical user interface is displayed on the host computer display (block 48). For example, the controller view may be a reduced size interface that allows a screen to be largely used for other functions, but still enables control of the video being played on the television. Then the computer automatically generates the output to the television by processing the video and creating an output presentation (block 49) (such as including annotation marks in the output stream or putting together two videos for side-by-side playback). Then the video is displayed on the television, as indicated in block 50.

Referring to FIG. 5, in accordance with one embodiment, a sequence for implementing the annotation engine 22 may be implemented in hardware, software, or firmware or any combination of these. In a software embodiment, a non-transitory medium may store computer executable instructions. At diamond 60, a check determines whether the current time equals the one or more annotation times when an annotation can be played in parallel to the video currently playing on the television 38. If so, an annotation icon is displayed on the television 38 display, as indicated in block 62. Then, a check at diamond 64 determines whether an annotation marker was selected on the controller view graphical user interface 28 by selecting one of the markers 29. If so, the annotation is then displayed on the computer display 36, in one embodiment, without obscuring the controller view 28, as indicated in block 66. In some embodiments, any previously displayed markers can be selected at any time.

Referring back to FIG. 1, in some embodiments, the personal computer 11 may be coupled to a Blu-Ray player 104. The Blu-Ray player may be an external component or a part of the computer system 11. Operation with the Blu-Ray player may work in a way similar to the way described already. Namely, in Blu-Ray disks, the information for controlling the play of the video is a separate stream from the information that makes up the video content. Thus, in accordance with some embodiments of the present invention, the display manager 18 can disaggregate the control and content information, for example, displaying the control information as a controller view on the computer system while displaying the video and additional content on the television display.

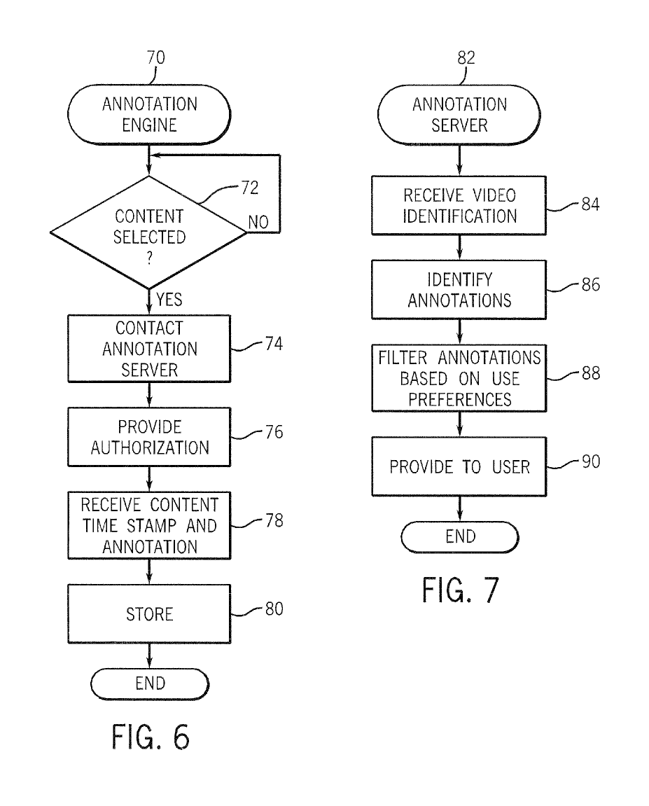

Referring to FIG. 6, in accordance with another embodiment of the present invention, an implementation of the annotation engine may operate effectively on the fly. Namely, the annotations may be assembled if and when the associated video is selected for play. When the associated video is selected for play, the system may automatically contact a remote server, in one embodiment, to obtain the necessary information about what the annotations are and where they should be inserted. Thus, in the course of calling up of the video for play, the annotations may be developed and inserted and the markers provided to indicate where the annotations would be active during the play of the video.

Referring to FIG. 6, the sequence 70 may be implemented in software, hardware, or firmware or a combination of these. In a software embodiment, it may be implemented as computer readable instructions stored on a non-transitory computer readable medium. A check at diamond 72 determines whether content has been selected. If so, an annotation server may be contacted, as indicated in block 74. In one embodiment, an authorization may be provided to the annotation server, as indicated in block 76, to indicate that the user is authorized to use the services provided by the annotation server. In response, the annotation engine may receive the content and time stamps that indicate where the annotations go with respect to the associated video, as indicated, in block 78. Then the information about the time stamps and the annotations may be stored, as indicated in block 80, for replay if selected by the user. In addition, the markers and other implementation details may either be populated at this point, or as the content playback reaches the timestamps of specific annotations.

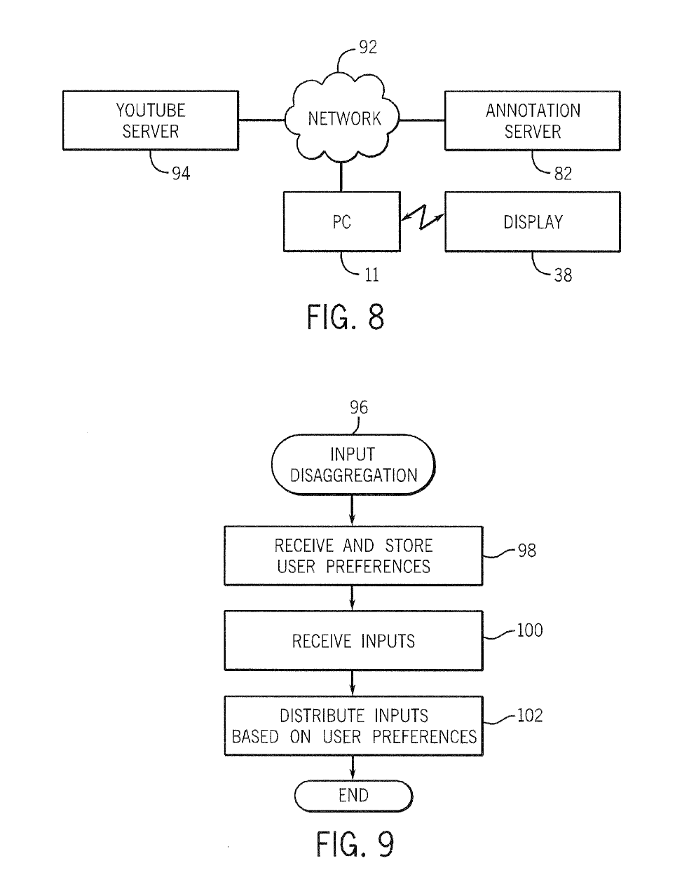

For example, referring to FIG. 8, a network configuration may have the computer system 11 coupled to the television display 38 through a wireless short range network, in one embodiment. The computer system may be also connected through a network 92 to remote servers, such as a YouTube video server 94 and an annotation server 82. The annotation server 82 may provide the annotations selected by the user or by other entities and the annotations including time stamps to indicate where the annotations go with respect to the play of an associated video.

Referring to FIG. 7, the operation of the annotation server 82 may be implemented as a sequence 82, which may be implemented in hardware, software, firmware, or a combination of these. In a software embodiment, computer executable instructions may be stored on a non-transitory computer readable medium. In accordance with one embodiment, the sequence begins by receiving an identification of a video, as indicated in block 84. For example, a YouTube video clip may be identified. Then, in block 86, the server identifies the annotations which are related to the video. Next, in block 88, annotations are filtered based on user preferences. For example, a user may wish to only get annotations made by friends and relatives or other restrictive groups. Thus, for example, a video on YouTube that may be viewed by a large number of people may be annotated by a large number of people, but the user may want to restrict the annotations that it receives to only those annotations of interest.

One way to define the annotations of interest would be to identify the individuals who are the only individuals of interest with respect to their annotations. Thus, as indicated in block 88, the annotations may be filtered based on user supplied preferences. For example, the user may wish to see annotations only from friends in a predefined social network or buddy list or those from an authoritative source, such as a trusted reviewer or publisher. Then the selected annotations, together with time stamps to indicate where the annotations go and together with an identification of the associated video, may be provided to the user, as indicated in block 90. The system can also allow users to insert their own annotations on the video. These annotations will be timestamped and saved on the annotation server if the user has the rights to do so.

Annotations can also be filtered locally as well. The local filtering can be contextual, based on user preferences, user purchasing patterns, or other criteria.

In accordance with still another embodiment, inputs to either the television or the computer system may be disaggregated. In the course of play of a selected video, inputs may be received on the computer system 11 and on the associated television 35. For example, some televisions now have keyboard and other input devices associated with them, as well as conventional remote controls. The inputs to the two different displays can be correlated in one embodiment. For example, a user may wish to make a phone call using the keyboard associated with the television and may want the call to go out through the computer system 11. In accordance with some embodiments, user preferences can be pre-supplied to indicate which of the two devices, (the television or the computer system) would handle particular input commands, regardless of which system's input devices were use. Then the inputs may be applied appropriately.

Thus, as shown in FIG. 9, a sequence 96 for input disaggregation may be implemented in hardware, software, firmware or a combination of these. In a software based embodiment, instructions may be stored in a non-transitory computer readable medium.

At block 98, user preferences are received and stored. These preferences indicate to which system an input should apply when received in the course of an ongoing video presentation. Then, in block 100, inputs may be received from the user. The system then distributes these inputs to the correct system, either the computer system or the television, based on those user preferences, as indicated in block 102.

In still other embodiments, sounds may be disambiguated from display. For example, in some embodiments, any sound that would have been generated on the computer system may be generated on the television when the extended television display is selected for play of video. Thus, indications of an incoming phone call, an incoming email, etc. may sound on the television. In some embodiments, this may be undesirable and the user can specify which of the computer system and the television should be used to generate particular sounds. As a result, audio outputs can be disambiguated from the video information. Particularly, audio may be linked to video so that audio for the presentation on the television may be presented on the speaker 118b, associated with the content that is assembled for display on the television and audio associated with content on the display for the computer system 11 may be played on the speaker 118a, associated with the computer display 36. This allows the computer system to be more effectively used for other functions while video is being played on the television, for example. In general, the audio related to a given graphical display element may be played by a speaker associated with the display on which that graphical view is presented.

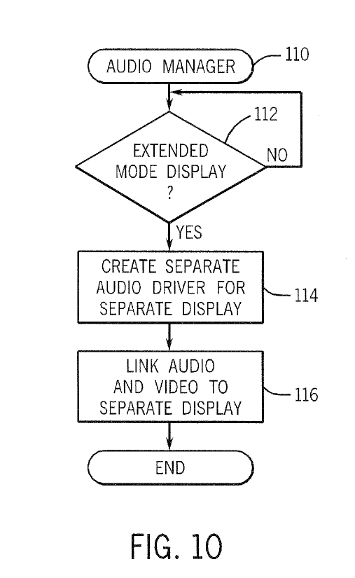

In accordance with some embodiments of the present invention, an audio manager 110 (FIG. 10) may implement a sequence in software, hardware, or firmware or a combination of these. In a software embodiment, the audio manager may be implemented by computer executable instructions stored on a non-transitory computer readable medium. In one embodiment, the audio manager 110 may be part of the display manager 18 (FIG. 1).

A check at diamond 112 determines whether an extended mode display has been initiated. If so, a separate display audio driver is created for the separate or extended display, as indicated in block 114. Thus, for example, when an extended display is set up on a remote television, sounds associated with elements being presented on the remote television display may be sent through the new audio driver to the separate display for presentation on speakers associated with that separate television display. At the same time, sounds associated with the computer system 11, such as sounds announcing incoming emails, do not get sent to the television display. Then the audio and video are linked together on the separate display, as indicated in block 116. Thus, in some embodiments, sounds associated with the separate or extended display are produced in association with that extended display and sounds associated with the host or base computer system 11 are generated locally on the system 11. In some embodiments, it may also be possible to program where sounds are generated. For example, sounds generated in association with the television may be programmably selected to also be displayed on the computer system. Likewise, it may be desirable to receive a notification on the television system of incoming emails or other audible alerts.

Thus, in some embodiments, remote control may be possible of the display of a video presentation on a television through the user's personal computer. In some embodiments, this can be done without co-opting the entire personal computer for this function. That is, video may be displayed on the television while doing other operations at the same time on a single display associated with the personal computer.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving and rendering video on a computer including a display;
sending the video for remote display on a television; and
enabling the playback of the resulting stream to be controlled from an interface overlaid on a portion of said computer display.

2. The method of claim 1 wherein receiving includes receiving video selected from the Internet for display on a television.

3. The method of claim 2 including enabling the video to be queued in a playlist for play on the television.

4. The method of claim 1 including automatically selecting among a plurality of displays for display of said video.

5. The method of claim 1 including providing a reduced sized graphical user interface on the computer display for controlling the display on said television.

6. The method of claim 1 including combining video with additional information available on the computer and sending the combined information for display on the television.

7. The method of claim 6 including providing icons to indicate the availability of an annotation associated with display on said television.

8. The method of claim 7 including providing an icon on the television when an annotation is available.

9. The method of claim 8 including enabling user selection of an annotation to be displayed on the computer display.

10. The method of claim 7 including providing an icon on said reduced sized display to indicate when an annotation is available for video being displayed on said television.

11. A non-transitory computer readable medium storing instructions to enable a computer to:
receive a request for content for playback; and
in response to a request for the content, request the content and any available annotations for said content from a remote server.

12. The medium of claim 11 further storing instructions to provide an authorization to said remote server with the request for content and annotations.

13. The medium of claim 11 further storing instructions to display said content on a television while displaying a user interface on said computer to control said television display.

14. A non-transitory computer readable medium storing instructions to enable a computer to:
receive an identification of a video;
in response to said video identification, identify any annotations associated with said video;
filter the annotations based on a user preference; and
provide the annotations to the user, together with an indication of where the annotations should be played during the play of said video.

15. The medium of claim 14 further storing instructions to filter annotations based on the author of the annotation.

16. The medium of claim 15 further storing instructions to filter annotations based on the user's buddy list.

17. The medium of claim 14 further storing instructions to display said content on a television while displaying a user interface on a computer display to control said television display.

18. An apparatus comprising:
a processor to control a first and second display and to provide audio associated with content on the first display generated by an application running on said processor to a first speaker associated with the first display and to provide audio associated with content on the second display generated by another application running on said processor to a second speaker associated with the first display; and
a storage coupled to said processor.

19. The apparatus of claim 18, said processor to create an audio driver on said apparatus for content played on said second display.

20. The medium of claim 18 further storing instructions to display said content on a television while displaying a user interface on said apparatus to control said television display.
